(19) United States
(12) Patent Application Publication
(10) Pub. No.: US 2005/0283962 A1
(43) Pub. Date: Dec. 29, 2005

(54) Method for making a medical implant with open-work structure and implant obtained by said method

(76) Inventor: Younes Boudjemline, Creteil (FR)

Correspondence Address: YOUNG & THOMPSON, 745 SOUTH 23RD STREET, 2ND FLOOR, ARLINGTON, VA, 22202, US

(21) Appl. No.: 10/514,329

(22) PCT Filed: Nov. 5, 2003
(86) PCT No.: PCT/FR03/03296

§ 371 Date: Jul. 6, 2005

(30) Foreign Application Priority Data
Nov. 20, 2002 (FR) 02/14522

(51) Int. Cl. B23P 19/04

(52) U.S. Cl. 29/433

(57) ABSTRACT

This process comprises the step consisting in forming the structure from a single wire, by running each strand of wire helicoidally from one end to the other of the structure and by interlacing this strand with other strands previously arranged. Said method moreover comprises the steps consisting in:—forming a loop (12) between each strand (11b, 11c) at each end of the structure (10) and setting the free ends of the first (11b) and of the last strand significantly back from the ends of the structure (10).

The present invention concerns a method of production of a medical implant with a mesh-like structure, notably of a device for the treatment of a corporeal duct currently denominated as “stent” or of an implant able to plug a hole in a corporeal wall, currently denominated as “plug”. The invention also concerns an implant obtained by this method.

It is well-known to restore the section of the lumen of a corporeal duct by means of a tubular extension. This extension, currently denominated as “stent”, is deformable between a contraction state, enabling its introduction and its sliding in corporeal ducts up to the site to be treated, and a deployed state, wherein it rests against the wall of the conduit to be treated and restores said section of the conduit. Such a stent may also be used for implanting a prosthetic system in a corporeal duct, for instance a cardiac valve, or to isolate an arterial hernia.

It is also well-known to plug a hole in a corporeal wall by means of a two-collar implant, currently denominated as “plug”, each of these collars resting against one of the faces of the wall to be treated.

There exist numerous models of stents or of plugs, notably stents formed by laser-cutting a thin sheet of appropriate metal material or formed by braiding several metal wires, notably made of memory-shape alloy.

The shortcoming of these stents and plugs lies in their being relatively difficult to produce.

The shortcoming of the stents also lies in their being little adaptable as regards the variations in diameter which they may adopt, so that stents of different diameter must be produced for treating different corporeal ducts, of different diameters.

The shortcoming of the stents made of breaded wires lies moreover in their being relatively aggressive at their ends, which may have significant damaging consequences.

The document EP 0 857 471 describes several structures of stent, whereof two, with “trellis mesh” are difficult to produce and exhibit no adaptability of diameter or of shape. This document also describes a stent formed by a single wire whereof each strand runs helicoidally from one end to the other of the stent and is braided to the others strands. At the ends of the stent, each strand connects to the following strand by an elbow.

This structure of stent is considered as solving the shortcomings aforementioned only partially, particularly which concerns the adaptability of the diameter or of the shape of the stent and the character relatively aggressive of its ends. Besides, the free ends of the first and of the last strand appear able to protrude beyond ends of the stent when the diameter or the shape of this stent is modified, and be thus particularly aggressive for a corporeal duct.

The document U.S. 2002/169498 describes a stent with a “trellis mesh” structure, considered as difficult to produce and exhibiting no adaptability of diameter or of shape.

The purpose of the present invention is to remedy all the shortcomings aforementioned of methods of production of stents according to the prior art.

Its main object is hence to provide a method of production of a medical implant with mesh-like structure, notably a “stent” or a “plug”, relatively easy to implement and enabling the realisation of implants which are perfectly functional.

Another object of the invention is to provide a method enabling the realisation of a structure whereof the diameter and/or the shape may be vastly adapted to suit the needs.

Another object of the invention is to provide a method enabling the realisation of a stent which, whereas this stent has a given diameter, may be used in a wider range of corporeal ducts.

Another object still of the invention is to provide a method enabling the realisation of a stent whereof the ends are little aggressive for the walls of the corporeal duct treated.

The method comprises, in a manner known in itself, the step consisting in forming the structure from a single wire, by running each strand of wire helicoidally from one end to the other of the structure and by interlacing this strand with other strands previously arranged.

According to the invention, the method comprises moreover the steps consisting in:
forming a loop between each strand at each end of the structure; and
setting the free ends of the first and of the last strand significantly back from the ends of the structure.

Thus, the method according to the invention consists in:
a) using a single wire to form a tubular mesh-like structure;
b) forming a first strand whereof the free end is set significantly back from a first location corresponding to a first end of the structure to be realised and running this first strand along a helicoid path up to a second location corresponding to a second end of the structure to be realised, this first strand forming a loop at this second location, thus singling out a second strand;
c) running this second strand along a helicoid path up to said first location, by interlacing this second strand with the first strand when it meets the latter, said second strand formant a loop at this first location, thus singling out a following strand;
d) running this following strand along a helicoid path up to the opposite location, by interlacing this following strand with the front strand(s) on its way, this following strand forming a loop at said opposite location, thus singling out a following strand;
e) repeating the operations from the step d) above as many times as necessary to form a mesh-like tubular structure and loops on the whole circumference of said locations, up to singling out a last strand;
f) interlacing the last strand with the previous strand(s) on its way, and interrupting this last strand so that its free end is set significantly back from the opposite location.

Realising a structure from a single wire, combined to the arrangement of the loops between each strand of wire and to the setting of the free ends of the first and of the last strand significantly back from the ends of the structure, enables to slide the strands against one another, this sliding motion being rendered totally possible by clamping or expanding loops, according to the diameter or the shape given to the structure. The latter is thus vastly deformable in its diameter as well as in its shape, and remains non aggressive for the walls of a corporeal duct regardless of the diameter and/or the shape given thereto.

The absence of welded spots between the strands and the deformability of the loops also has as an essential advantage to enable significant variation of the angles formed by the strands therebetween. The multiples slides of these strands enable wider variability of the different diameters which said structure may exhibit, and hence the realisation of a stent having wider possibilities of variations in diameter, which enable the latter to be used for treating a wider range of diameters of corporeal ducts.

The loops formed by the wire at the ends of said structure partake of these wider possibilities of deformation and are moreover non aggressive for the wall of the corporeal duct treated.

The setting of the free ends of the first and of the last strand vastly back from the ends of the stent enable vast adaptations of the diameter and/or of the shape of the stent without risking that these ends protrude beyond the ends of the stent and should not form sharp excrescences for the corporeal duct to be treated.

The structure realised may be used as such as a tubular stent. It thus has a diameter which may vary easily or have a shape easily adaptable to the conformation of the corporeal site to be treated.

This structure may also be used s a blank for the realisation of a stent or of a “plug” of specific shapes. The method then comprises:
a step of deformation of the tubular structure obtained, according to the shape of the stent or of the “plug” to realised, and
a step of further treatment, enabling to stabilise this tubular structure in this state of deformation.

Preferably, interlacing a strand with the other strands encountered by this strand is performed as a braiding process, i.e. this strand runs alternately on a strand on its way then under the following strand, and so on.

This braiding confers said structure such a handling that it may be used as a stent or to serve as a blank for the production of other implants, notably plugs. This braiding enables moreover reliable stop of the first and of the last strands formed by the wire.

The wire used may notably be a wire made of a shape memory alloy, in particular the nickel-titanium alloy, known under the designation “NITINOL”.

The diameter of the wire used may range from 0.15 to 0.5 mm.

The diameter of the structures which may be produced by the method according to the invention is very wide, and range from 5 to 100 mm.

The method may contain the step consisting in placing on said structure a means for longitudinal shortening of this structure, able to switch from an elongated state to a shortened state.

This longitudinal shortening means enables the deployment of the structure, or to facilitate this deployment.

This longitudinal shortening means may be an elastic means, for instance a wristband made of elastic matter, notably of silicon; this means may also be with shape memory and switch from its elongated state to its shortcoming state by heating to the temperature of the body further to the implantation of the structure.

Said longitudinal shortening means may notably be engaged through two loops formed at the ends of said structure.

The method may moreover contain the step consisting in covering said structure of a watertight flexible wall, notably with a Teflon sheet sawed to this structure.

The latter is thus watertight and may isolate an arterial hernia when in place.

The invention will be better understood, and other characteristics and advantages thereof will appear, with reference to the appended schematic drawing, representing, for non limiting exemplification purposes, several structures of implant obtained by the method concerned.

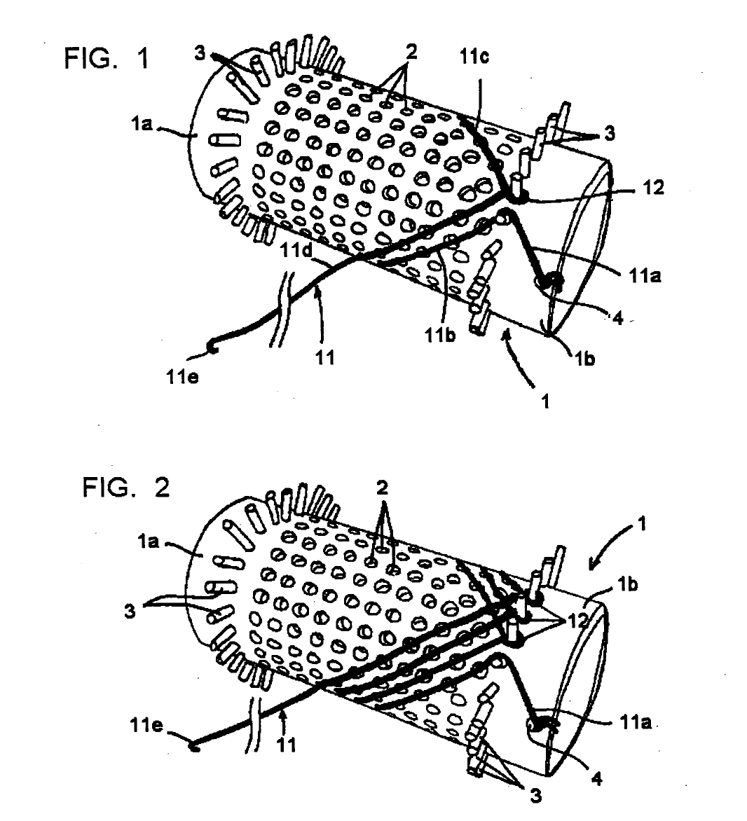

FIGS. 1 to 4 are perspective views of a device used for implementing this method, showing respectively four successive steps contained in this method;

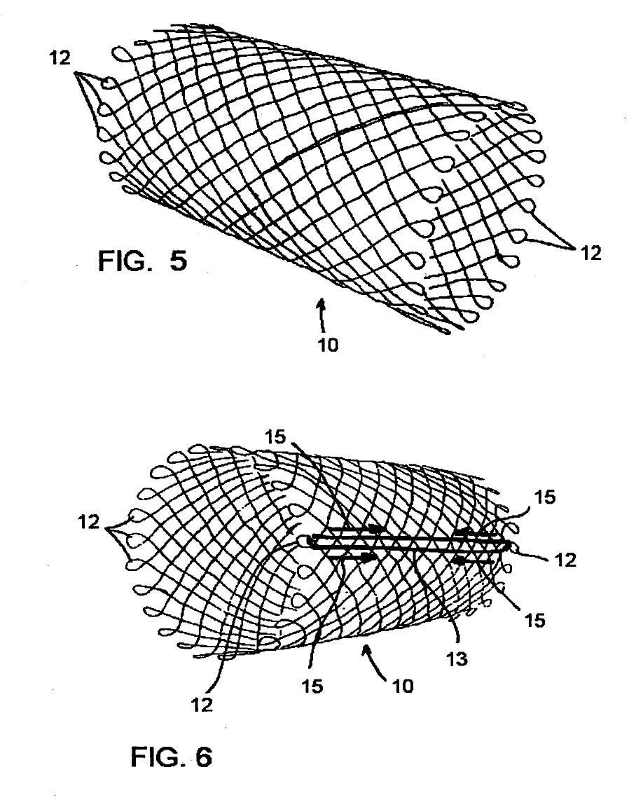

FIG. 5 is a perspective view of the mesh-like tubular structure obtained; for clarity of the drawing, this structure is fictitiously represented as opaque, the portions at the foreground masking the portions at the background;

FIG. 6 is a view of said structure similar to FIG. 5, below another angle, the structure being fitted with an elastic wristband forming a longitudinal shortening means;

FIG. 7 is a perspective view of another device used for implementing this method;

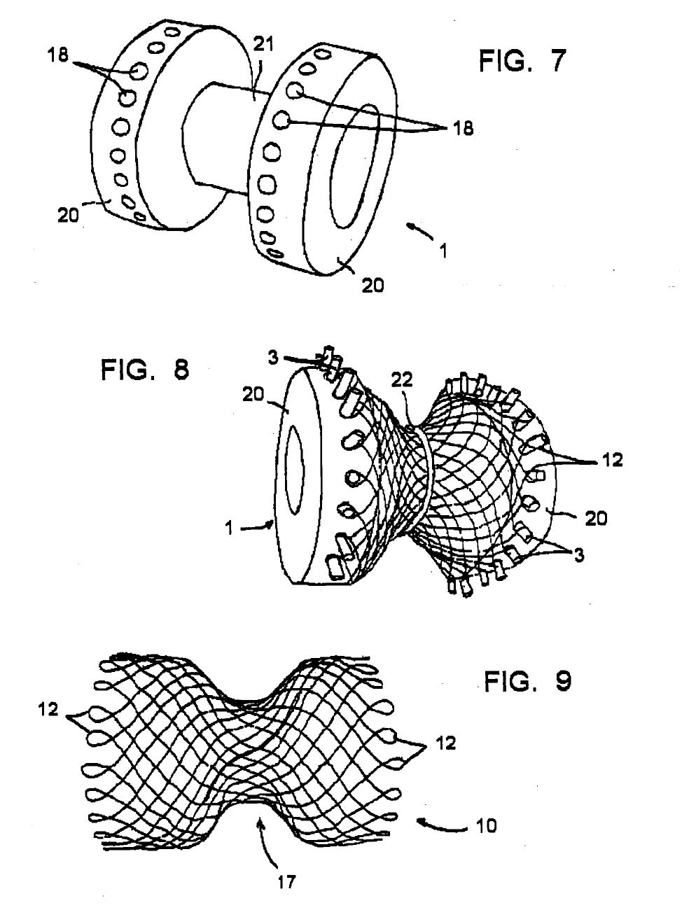

FIG. 8 is a perspective view of this device with placement of a mesh-like tubular structure thereon;

FIG. 9 is a view of this mesh-like tubular structure, after retraction outside the device; here also, this structure is fictitiously represented as opaque;

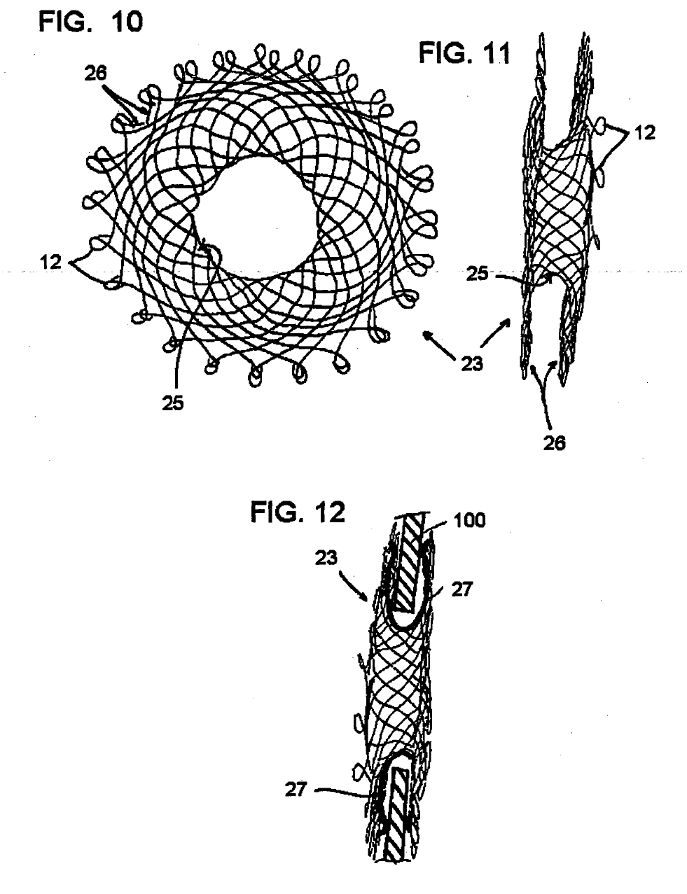

FIGS. 10 to 12 are face, side and sectional views, respectively, after placing on a corporeal wall, of an implant obtained from the mesh-like tubular structure shown on FIG. 9, this implant being intended for blanking a hole existing in a corporeal wall;

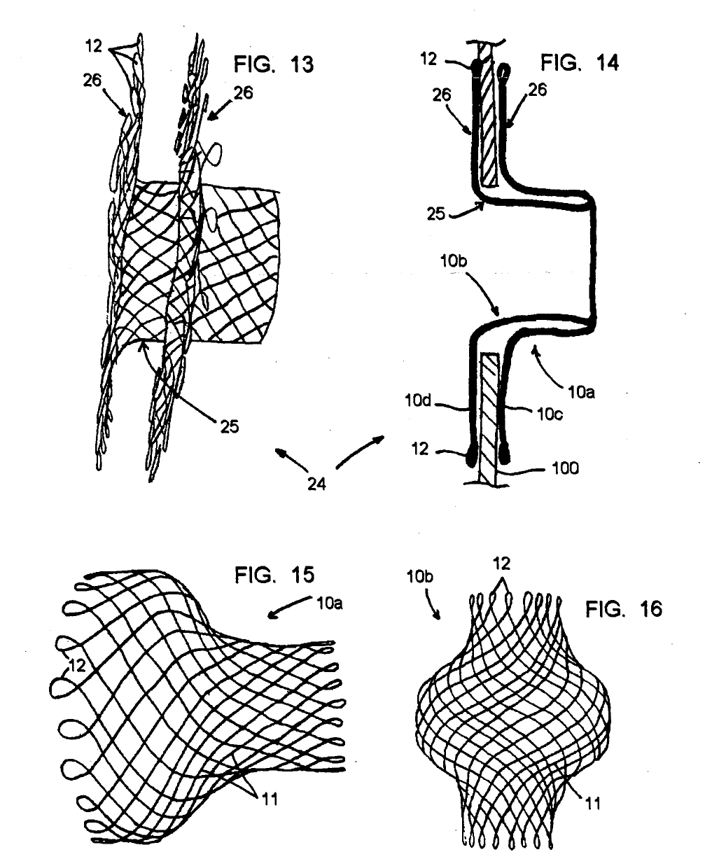

FIGS. 13 and 14 are side and sectional views, respectively, after placing on a corporeal wall, of another implant obtained from of the mesh-like tubular structure shown on FIG. 9, this implant being also intended for blanking a hole existing in a corporeal wall; and

FIGS. 15 and 16 are side views of both examples of mesh-like tubular structures which may be obtained by the method according to the invention.

For simplification purposes, the portions or element present on these different devices and structures will be designated by the same numeric references and will not be described again.

FIG. 1 represents a tubular chuck 1 drilled with holes 2 evenly distributed on its wall, these holes 2 being aligned longitudinally and transversally. On its longitudinal ends 1a, 1b, the chuck 1 comprises series of holes evenly distributed on its circumference, receiving with frictions, but with removability, cylindrical studs 3.

The chuck 1 comprises moreover a hole 4 provided slightly recessed from one of its ends 1b.

The chuck 1 is intended to be used for producing a mesh-like tubular structure 10 as shown on FIGS. 5 and 6, by means of a single metal wire 11. This wire 11 is notably made of shape memory alloy known under the designation “NITINOL”.

To produce the structure 10, an appropriate length of wire 11 is cut, for instance four metres, and one end 11a of wire is attached to the chuck 1 by engagement in the hole 4 and around the end edge of the chuck 1 then twisting this end 11a around itself.

The wire 11 is then run around a stud 3 of the end 1b slightly offset angularly, then along the wall of the chuck 1, along a helicoid path running above holes 2 aligned on this path.

The first strand 11b of wire thus formed runs along the wall of the chuck 1 then is engaged around the stud 3 corresponding to the end 1a, by forming a loop around this stud 3, thus singling out a second strand 11c.

As shown on FIG. 1, this second strand 11c is run along the wall of the chuck 1 along a helicoid path until it comes back to a corresponding stud 3 of the end 1b and form a loop 12 around the latter, thus singling out a following strand 11d. In the example represented, the number of holes 2 and of studs 3 is determined so that this second strand 11c comes back to the stud 3 adjoining the stud 3 around which is engaged the previous strand 11b.

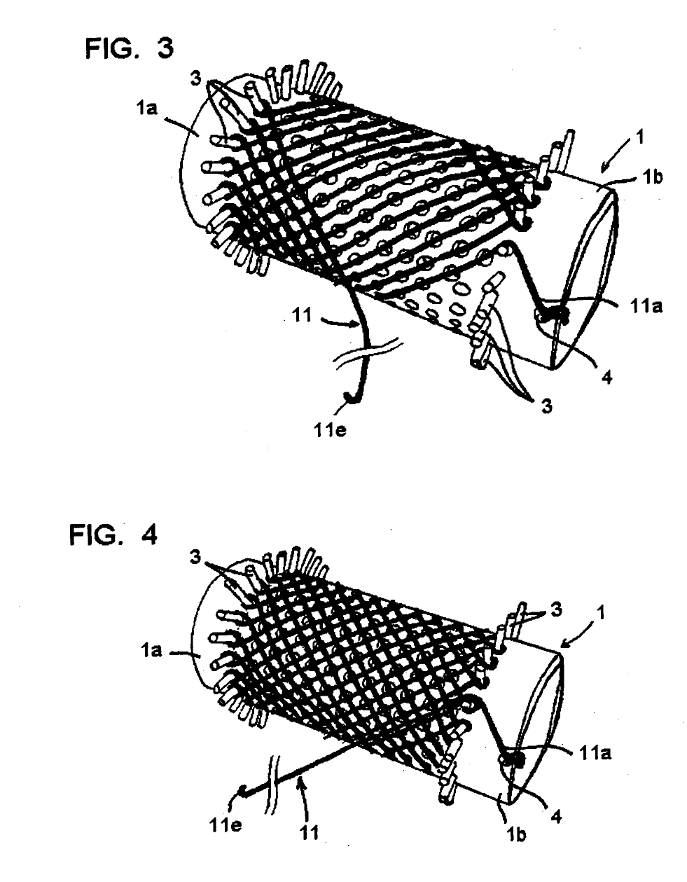

As can be deduced from FIGS. 2 and 3, these engagement operations of a strand along the wall of the chuck 1 via a helicoid path, thereby forming a loop 12 around a corresponding stud 3 are repeated as many times as necessary for the formation of the tubular mesh-like structure 10, visible on FIG. 4 whereas it is practically finished.

Each strand is braided with the others strands on its way, i.e. runs alternately over a strand on its way then below the following strand, and so on. This braiding is facilitated by the holes 2 and by the conformation of the free end 11e of the wire 11 into a hook.

The last strand is braided with the strands on its way, then the end of this strand is cut to the desired length, so that it is set back from the corresponding end of the chuck 1, i.e. the end 1a in the example represented.

The first strand 11b is then cut to the desired length, so that its end is set back from the end 1b, then the studs 3 are extracted from the holes which receive said studs in order to free the structure 10 and to enable to remove said studs from the chuck 1 by a sliding motion.

The structure 10 thus constituted does not comprise therefore any welding spots between the strands of wire 11, nor braids at its ends, but loops 12. The absence of welding spots between the strands and the existence of these loops 12 enable to slide the strands against one another when antagonistic stresses are exerted transversally on the structure 10, and this sliding enables a significant variation of the angles formed by the strands therebetween and hence of the diameter which said structure 10 may acquire.

The latter may be used as such and constitute an extension of corporeal duct currently denominated as “stent”. After production as aforementioned, it is exposed in such a case to one or several thermal treatments enabling to stabilise its form and to confer supra-elastic properties thereto.

This stent has hence wider possibilities of variations in diameter, which enable it to be used for treating a wider range of diameters of corporeal ducts.

The structure 10 may also be deformed to constitute a stent of smaller or of larger diameter, or a stent of particular shape, for instance with a median narrowing. An appropriate contention device, holding the structure 10 in the shape to obtain before thermal treatment, is used in each case, i.e. a contention tube for the production of a stent of smaller diameter, a chuck of diameter larger than the chuck 1 for the production of a stent of larger diameter, or an appropriate shape in the other cases. FIGS. 15 and 16 show in this view two examples of mesh-like structures 10A, 10B obtained by braiding on a chuck of appropriate shape or by deformation of the structure 10 then thermal treatment thereof in deformed condition, i.e. a structure 10A whereof one end is flared and a structure 10B whereof the median zone is bulged. The structure 10A may notably serve as a stent for treating a Fallot tetralogy, and the structure 10B may notably serve as an aortic stent for placing an aortic valve, the bulged zone being adaptable to the Valsalva sinus.

FIG. 6 shows a structure 10 obtained as described previously, whereon has been placed a wristband 13 made of silicon, engaged through two loops 12 substantially aligned longitudinally. This wristband 13 is elastic and is stretched when the structure 10 is in a radial contraction condition, taking into account the closing of the angles formed by the strands therebetween during this contraction, and hence the increase in length of the structure 10. When this contraction is released, when placing the implant formed by this structure, the wristband 13 tends to regain its non-stretched shape, as shown by the arrows 15. This wristband 13 provides consequently, and readily, a longitudinal shortening means of said structure 10, which enables or promotes the deployment of this structure 10.

FIGS. 7 to 9 show a chuck 1 designed to enable the production of a structure of stent 10 shown on FIG. 9, comprising a central narrowing 17.

The chuck 1 comprises in this case two portions 20 of longitudinal ends of larger diameter and a median portion 21 of smaller diameter. The portions 20 comprise the holes 18 receiving the studs 3.

One of the portions 20 is dismountable with respect to the portion 21, to enable retraction of the structure 10 obtained outside the chuck 1.

A structure 10 as shown on FIG. 5 is placed on this chuck 1, the length of the latter being such that the strands extend loosely between the studs 3 to enable the arrangement of said narrowing 17. The loops 12 enable perfect maintenance of the structure 10 on the chuck 1 by means of the studs 3.

One or several contention wires 22 is then used to form the narrowed median portion 17 of the structure 10, as shown on FIG. 8, to shape the stent adequately and to keep its shape during the single or various subsequent thermal treatments.

The stent thus obtained is notably intended to place a prosthetic valve in a corporeal duct. It is covered with a watertight sheet, notably made of Teflon.

The structure 10 with narrow portion 17 shown on FIG. 9 may also serve as a blank for the production of implants 23, 24 as shown on FIGS. 10 to 14.

The implant 23 is of the type currently designated as “plug”, liable to plug a hole in a corporeal wall 100, notably an interventricular hole in a heart. It comprises to this end a median portion 25 intended to be engaged in said hole, one or two collars 26 adjoining this central portion 25, liable to rest against said wall 100, on both sides thereof, and a material sheet blanking the opening formed by the median portion 25, notably a Teflon sheet.

In the case of this implant 23, shown on FIGS. 10 to 12, both end portions of the structure 10 are folded radially towards the outside of this structure, to form both collars 26. This deformation is made possible by the deformation properties of the structure 10 detailed previously. The structure 10, thus deformed, is placed in a contention temps, holding it in this position in order to carry out the single or various thermal treatments aforementioned.

FIG. 12 shows that the implant 23 may receive one or several elastic clips 27 maintaining both collars 26 on both sides of the wall 100.

The implant 24 shown on FIGS. 13 and 14 is, for its own part, designed for receiving a prosthetic valve and enabling its assembly on a wall or similar corporeal zone. In this case, a portion 10a corresponding to slightly less than the longitudinal half of the structure 10 is folded on the other portion 10b of this structure 10 then is folded radially towards the outside at its portion of free end 10c, to form thus one of both collars 26. The end portion 10d of the other portion 10b of the structure 10 opposite portion 10a is folded radially towards the outside, and enables to form the other collar 26.

As previously, the structure 10 thus deformed is placed in a contention device which maintains it in this shape and is then exposed to a single or to various appropriate thermal treatments stabilising its shape and conferring super elastic properties thereto. The implant 24 receives also a watertight sheet which covers said implant, notably made of Teflon.

As appears from the foregoing, the invention provides a method of production of a medical implant with mesh-like structure, notably of a “stent” or of a “plug”, relatively easy to implement and enabling the realisation of implants 10, 23, 24 remaining perfectly functional.

It goes without saying that the invention is not limited to the embodiment described above for exemplification purposes but it extends to all the embodiments covered by the claims appended thereto.

1. A method of production of a medical implant (10,23,24) with a mesh-like structure, notably of a device for the treatment of a corporeal duct currently denominated as “stent” or of an implant able to plug a hole in a corporeal wall, currently denominated as “plug”, comprising the step consisting in forming the structure from a single wire, by running each strand of wire helicoidally from one end to the other of the structure and by interlacing this strand with other strands previously arranged:
wherein the method moreover comprises the steps consisting in
forming a loop (12) between each strand at (11b, 11c) at each end of the structure (10); and
setting the free ends of the first (11b) and of the last strand significantly back from the ends of the structure (10).

2. A method according to claim 1, characterized in that it comprises:
a step of deformation of the tubular structure (10) obtained, according to the shape of the stent or of the “plug” to realised, and
a step of further treatment, enabling to stabilise this tubular structure (10) in this state of deformation.

3. A method according to claim 2, characterized in that said step of deformation of the tubular structure (10) obtained consists in reducing the diameter of this structure (10), for obtaining a stent of a smaller diameter than that of this structure (10).

4. A method according to claim 2, characterized in that said step of deformation of the tubular structure (10) obtained consists in increasing the diameter of this structure (10), for obtaining a stent of a larger diameter than that of this structure (10).

5. A method according to claim 2, characterized in that said step of deformation of the tubular structure (10) obtained consists in making at least one narrowing of this structure (10).

6. A method according to claim 2, characterized in that said step of deformation of the tubular structure (10) obtained consists in folding at least one end part of this structure (10), radially towards the outside, to form at least a substantially flat collar (26), said tubular structure (10) obtained thus permetting to make an implant (23, 24) able to plug a hole in a corporeal wall.

7. A method according to claim 1, characterized in that interlacing a strand with the other strands encountered by this strand is performed as a braiding process, i.e. this strand runs alternately over a strand in its way then under the following strand, and so on.

8. A method according to claim 1, characterized in that the wire (11) used is a wire (11) made of a shape memory alloy, in particular the nickel-titanium alloy, known under the designation “NITINOL”.

9. A method according to claim 1, characterized in that the diameter of the wire (11) used ranges from 0.15 to 0.5 mm.

10. A method according to claim 1, characterized in that it comprises the step consisting in placing on said structure (10) a means (13) for longitudinal shortening of this structure (10), able to switch from an elongated state to a shortened state.

11. A method according to claim 1, characterized in that it comprises the step consisting in covering said structure (10) with a watertight flexible wall.

12. Implant with a mesh-like structure as obtained by the method according to claim 1.

13. A method according to claim 2, characterized in that interlacing a strand with the other strands encountered by this strand is performed as a braiding process, i.e. this strand runs alternately over a strand in its way then under the following strand, and so on.

14. A method according to claim 3, characterized in that interlacing a strand with the other strands encountered by this strand is performed as a braiding process, i.e. this strand runs alternately over a strand in its way then under the following strand, and so on.

15. A method according to claim 4, characterized in that interlacing a strand with the other strands encountered by this strand is performed as a braiding process, i.e. this strand runs alternately over a strand in its way then under the following strand, and so on.

16. A method according to claim 5, characterized in that interlacing a strand with the other strands encountered by this strand is performed as a braiding process, i.e. this strand runs alternately over a strand in its way then under the following strand, and so on.

17. A method according to claim 6, characterized in that interlacing a strand with the other strands encountered by this strand is performed as a braiding process, i.e. this strand runs alternately over a strand in its way then under the following strand, and so on.

18. A method according to claim 2, characterized in that the wire (11) used is a wire (11) made of a shape memory alloy, in particular the nickel-titanium alloy, known under the designation “NITINOL”.

19. A method according to claim 3, characterized in that the wire (11) used is a wire (11) made of a shape memory alloy, in particular the nickel-titanium alloy, known under the designation “NITINOL”.

20. A method according to claim 4, characterized in that the wire (11) used is a wire (11) made of a shape memory alloy, in particular the nickel-titanium alloy, known under the designation “NITINOL”.
